(19) United States
(12) Patent Application Publication
(10) Pub. No.: US 2014/0310015 A1
(43) Pub. Date: Oct. 16, 2014

(54) SYSTEM AND PROCESS FOR MATCHING PATIENTS WITH AVAILABLE CLINICAL TRIALS

(71) Applicant: CURELAUNCHER, INC., Bloomfield Hills, MI (US)

(72) Inventor: Stephen Goldner, Bloomfield Hills, MI (US)

(73) Assignee: CURELAUNCHER, INC., Bloomfield Hills, MI (US)

(21) Appl. No.: 14/249,651

(22) Filed: Apr. 10, 2014

Related U.S. Application Data
(60) Provisional application No. 61/810,467, filed on Apr. 10, 2013.

(51) Int. Cl. G06F 19/00

(52) U.S. Cl. CPC G06F 19/363
USPC 705/2

(57) ABSTRACT

A system for matching patients to available clinical trials. The process includes a computer with a CPU having a processor, memory and an electronic database. The electronic database has a language equivalency database with a thesaurus of medical terminology and a regular language translator. Also, the regular language translator is operable to translate medical terms in the thesaurus of medical terminology into regular language terms such that a patient survey using regular language is generated and responded to by a patient. Also, the system identifies available clinical trials for the patient based on the responses by the patient.

### RELATED APPLICATION

The instant application claims priority to U.S. Provisional Application Ser. No. 61/810,467 filed on Apr. 10, 2013, the contents of which are included in their entirety herein by reference.

### FIELD OF THE INVENTION

The instant application is related to clinical trials, and in particular to a system and process for matching patients with available clinical trials.

### BACKGROUND OF THE INVENTION

Clinical trials for new drugs, medical devices, therapies, treatment programs, and the like are known. It is also known that companies sponsor such clinical trials, such companies including pharmaceutical companies, biotech companies, medical device companies, clinical research organizations, site management organizations, hospitals, etc. In addition, clinical trials can be an important step before obtaining Food and Drug Administration (FDA) approval for particular drugs, medical devices, etc.

Patients that have a particular disease, health problem, etc. can enroll in one or more appropriate clinical trials if they know the clinical trials exists, meet criteria to be included in the trials and are willing to abide/follow trial rules and procedures. However, knowledge of which clinical trials are currently available in a particular geographic location can be difficult to determine. Even more difficult, can be a patient trying to determine whether or not they meet the criteria established by or for a particular clinical trial. Therefore, a system and process for matching a patient with one or more available clinical trials independent of any company, hospital, etc. that is sponsoring the one or more trials would be desirable.

### SUMMARY OF THE INVENTION

A system for matching patients to available clinical trials is provided. The process includes a computer with a CPU having a processor, memory and an electronic database. The electronic database has a language equivalency database with a thesaurus of medical terminology and a regular language translator. Also, the regular language translator is operable to translate medical terms in the thesaurus of medical terminology into regular language terms.

The electronic database can also have a clinical trials database with data on available clinical trials within a given geographic area. A patient survey module with a plurality of questions generated from the regular language translator by the computer is also included, and the patient survey module is operable to accept answers to the plurality of questions as patient data. The computer also has a clinical trial matching module operable to select an available clinical trial for a patient as a function of the patient data.

In some instances, the plurality of questions are a series of sequential questions with previous questions and subsequent questions. Also, the patient survey module is operable to alter at least one subsequent question as a function of patient data accepted for at least one previous question. As such, the plurality of questions can be in the form of a logic tree. The system can further include a message module that is operable to send selected available clinical trial data to a patient, a caregiver, a specific clinical trial location and/or a clinical trial sponsor.

The patient data can be obtained directly from a patient during a conversation therewith. In some instances, the conversation is a phone conversation, however this is not required. For example, the patient data can be obtained from a hospital database, an insurance company database, an online health community, a social media network, a patient advocacy organization, and the like. In addition, the patient data from the hospital database, insurance company database, etc., can be translated into answers for the plurality of questions by the regular language translator.

A process for matching a patient to an available clinical trial is also provided. The process includes providing the system disclosed herein and generating a patient survey with a plurality of questions. Also, answers to the plurality of questions are obtained from a patient and the answers are entered into the patient survey. Thereafter, an available trial for the patient is selected as a function of the answers.

### BRIEF DESCRIPTION OF THE DRAWINGS

FIG. 1 is a schematic illustration of a system and process according to an embodiment of the present invention;

FIGS. 2A-2D are schematic illustrations of tables of regular language questions generated by the system and process according to an embodiment of the present invention;

FIG. 3 is a list of available clinical trials provided by the system and process according to an embodiment of the present invention;

FIG. 4 depicts a block diagram illustrating the system of the present invention;

FIG. 5 depicts a flowchart illustrating a method of matching a patient with available clinical trial sites and prequalifying patients for clinical trials; and

FIGS. 6A-6D depict block diagrams illustrating some exemplary links between various records in data storage device 120;

FIG. 7 is a schematic illustration of a system according to an embodiment of the present invention.

### DETAILED DESCRIPTION OF THE PRESENT INVENTION

The present invention provides a system and a process for matching patients with available clinical trials independent of any pharmaceutical company, hospital, etc. that is associated with and/or sponsoring the trials. As such, the present invention has use for matching patients with available clinical trials.

The invention includes creating a thesaurus of medical terminology in a language equivalency database. In addition, by entering a medical term or terminology within the language equivalency database, a “regular language” synonym is provided and can be used to generate a survey or questionnaire that can be easily understood by a patient. In some instances, the translation of the medical terminology or terms is performed using a computer with a software module that affords for the regular language synonym to be “called up” and displayed, printed, emailed, faxed, or the like when a corresponding medical term or terminology is entered into a software module by a user at a computer terminal. It is appreciated that the “regular language” can be in different speaking languages. For example, the regular language can be an American English regular language when the system and/or process is being used in the United States, British English when the system and/or process is being used in the United Kingdom, etc. In addition, the regular language can be regular foreign language used in a given country, e.g. a Spanish regular language when interacting with a Spanish speaking patient in an English speaking country.

Repetition of the entering of medical terms or terminology into the software module creates a list of phrases considered to be substitutable, one for the other. The list of phrases includes many equivalencies, each one being one or more simple regular language words or expressions that translate complex medical terms used to describe a medical/clinical evaluation word or phrase into a simple word or phrase that can be understood by a patient having regular language skills. In addition, the computer with the software module is programmed to search the database for equivalent words or phrases of the medical term, terms, etc. and display the equivalent word or expression to the user.

The term “medical terms and terminology” includes terms, phrases and the like used by one skilled in the art to describe a human, animal and/or plant, and associated components, conditions, processes in a science-based manner. Inclusion of laboratory data from genome analysis of an individual, the “individual” being a human, animal, or plant, is also included within the meaning or definition of medical terms and terminology. Thus the present invention can be seen useful for ‘personalized medicine and scientific analysis’ as a service to individuals, medical practitioners, medical experimenters, clinical trial sites and sponsors, selective breeding and husbandry practitioners of both animal and plant species, including the production of chemicals, natural substances and medicines therefrom. Examples of such laboratory data include, without restriction, the genome site, record of activity or inactivity, marker identification, and any other term or terminology that might be developed to facilitate the practice of this invention.

A database that can be queried is thus created which allows for the user of the computer to enter a series of answers to preselected or preprogrammed question categories as the computer displays the questions to the user. For example and for illustrative purposes only, an Excel spreadsheet can be created with a number of categories, e.g. no fewer than 2 categories and no more than 35 categories. In addition, the user of the computer can enter an answer to one of the simple regular language expressions into the spreadsheet by simply selecting a prior designated column and/or row and/or cell, e.g. by placing an “X” in the appropriate location. It is appreciated that the user of the computer can be in communication with a patient, e.g. talking with a patient over the phone, and based on the selections or answers to the regular language expressions, the same or another software module can utilize data from the spreadsheet to create a personalized clinical trial selection list for the patient. It is also appreciated that the data input into the spreadsheet by the user of the computer can receive the data via fax, email, and the like.

The categories of questions can describe possible physical, medical, clinical, and/or scientific properties of any person for any medical test, clinical trial, diagnosis, medical state, psychological state, mental state, emotional state, etc. determined either by objective and/or subjective questions.

In some instances, the software module affords for the display of questions that are worded in regular language to the user of the computer. As answers are entered into the software module by the user, additional questions can be displayed. In addition, depending upon an answer for a particular question, the software module can provide a following question that is a function of the answer to the previous question. In this manner, a process of elimination, which may be considered a logic tree, is followed until sufficient questions and answers have been provided that afford for a match between a patient and a clinical trial and/or medical therapy that is currently available for participation or registration therein.

The invention can also include the user of the computer to send an email, fax, and the like to the patient who has answered the plurality of questions mentioned above. The email, fax, and the like can also be sent to a caregiver and/or any other entities or people involved in a given transaction such as medical personnel, clinical trial sites, hospitals, medical clinics, etc. The email, fax, printout, etc. may list various types of information derived from the search process mentioned above, such as a list of matching clinical trials, matching clinical trial sites, matching therapy or treatments, drug regimens, exercise programs, etc. In addition, patient information and/or identification that may be necessary to a medical, financial, and/or matching process can be provided.

For the purposes of the present invention, the term “simple regular language” or “regular language” can be defined as a sentence or phrase with no greater than 12 words, no less than 1 word, and with each word containing no more than 4 syllables. Furthermore, each sentence or phrase is written in simple declarative grammatical form and format such that commas, semicolons, and other such methods for denoting subjunctive or subordinate expressions are minimized and preferably eliminated. The term “regular language” can also include a list of words or vocabulary provided by known and recognized educational institutions. For example and illustrative purposes only, vocabulary provided by the Berkeley, Calif. School District for a fifth grade level in combination with the discussion above with respect to a sentence or phrase with no greater than 12 words can be used to describe fifth grade language. Finally, it should be appreciated that the term regular language can include key sentences for many different scenarios that are used in everyday life (http://www.talkenglish.com/Speaking/listregular.aspx).

Such a vocabulary list as mentioned above can include the words: accurate, additionally, address, advantage/disadvantage, analyze, arguably, assert, available, citation, cite, complement, complex, condition, contradiction, contrary, coordinate, correspond, crucial, data, debate discriminate, drawback (benefit), eliminate, emphasize, encounter, establish, evaluate, eventually excess(ive)(ly), expand, focus, fundamental, including, infer/inference, interact, interaction, issue, limited, negate, note, object to, overall, persuade, primary/primarily, procedure, product, properties, quality, reflect, restrict, restricted, result, significantly, source, suggest, transition ultimate(ly), valid, variation, and volume (http://www.berkeleyschools. net/wp-content/uploads/2013/05/BUSD_Academic_Vocabulary.pdf). It is appreciated that other common words related to medical terms such as asthma, heart attack, high blood pressure, cancer and the like are included in regular language.

The term “useful descriptions” as used herein can mean a description of a person's medical condition and physical facts or allegations suitable to simply describe a person and match them to a treatment, diagnosis, drug, medical device, intake hospital, clinic, and the like. In addition, useful descriptions can also be used to provide a survey form used to match a person with at least one clinical trial.

Examples of categories of questions include personal information such as a zip code of a patient, a city or state where a patient lives, an email address for a patient, a telephone number for a patient, a name for a patient, an amount of interest for participating in a clinical trial and/or medical treatment, and the like. Examples of possible physical, medical, clinical, and/or scientific properties for a patient include age of a patient, disease status of a patient, description of amount to which the disease has progressed for the patient, description of disease as to whether or not it is repetitive or non-repetitive in nature, subjective or objective description of pain, physical/mental capacity/financial ability to travel beyond the patient's immediate location, physical and mental capacity to knowingly follow medical procedures and behave in a compliant or appropriate manner, and the like.

Examples of simple regular language can include sentences like: Richard Jones is the name of the patient. He is 39 years old. Richard has stage 3 lung cancer. He can leave his house and travel anywhere. Richard has taken no treatment drugs at this time. He is worried about dying. The patient wants to be in a clinical trial. The cancer has not spread to anywhere else in his body. Richard lives in New York, N.Y. Richard's zip code is 11106. Richard has or feels a small amount of pain at all times. Richard understands everything and knows what is being said to him during a telephone conversation. Naturally, such simple regular language sentences can be translated into different languages such as Spanish, French, German, Russian, Japanese, Chinese, etc.

Upon determination of answers that provide such regular grade language answers as discussed above, a database containing all available clinical trials within a geographic location, e.g. a particular state or the entire country, can be searched and trials that are appropriate for a patient that provide such answers can be identified, selected, and provided to the patient. In addition, subsequent to the conclusion of such a matching process, the user of the computer can indicate or instruct the computer that an email, fax, or printout is to be created and sent to the patient, a caregiver, and/or any other entities or people involved in the matching process such as medical personnel, clinical trial sites, hospitals, medical clinics, and the like. Also, the user of the computer upon finding appropriate clinical trials for the patient to participate in, can assist the patient for registering in such a trial, e.g. contacting one or more clinical trial contact individuals and setting up an appointment for the patient to travel to the clinic and be interviewed. It is appreciated that all such communication, contacting of the clinical trials, and the like are in compliance with HIPAA patient privacy regulations.

In some instances, clinical trial sites, hospitals, etc. can provide a payment to the user of the computer and/or an employer or organization connected with the user of the computer for matching the patient with the clinical trial that is being conducted or will be conducted at the clinical trial site. In this manner, the user of the computer and/or an employer or organization associated with the user of the computer has no obligation to prefer one clinical trial or clinical trial site over another clinical trial or clinical trial site based on whether or not a particular pharmaceutical company is sponsoring a clinical trial; whether or not a particular medical device company is sponsoring a clinical trial; whether or not a particular company, organization, hospital, etc. is sponsoring a particular clinical trial; and the like. Stated differently, the source of revenue for the user and/or an employer or organization associated with the user is from the actual individual clinical trial sites that have been matched for a particular patient and not from a company or organization that is funding the matching service or provider.

For illustrative purposes only, and in no way limiting the scope of the invention, an example based on actual data provided by a patient is provided below which demonstrates the effectiveness and unexpected results of the current invention.

A patient searched the Internet for known clinical trial matching services and after finding a matching service (hereafter referred to as “Service A”) contacted Service A via telephone and spoke with a Service A representative. The patient stated that he/she lived in the state of Michigan and had triple-negative breast cancer. The matching service said that there were no triple-negative breast cancer trials in the state of Michigan and that in fact the closest clinical trial the patient could participate in was located in the state of Arkansas.

The patient then asked if the matching service could provide a list of all possible trials in the United States via email. The Service A representative answered in the affirmative and upon providing an email address, approximately ten emails arrived at the patient's email inbox within the next 25 minutes. The ten emails consisted of a list of nine available trials within the United States. Out of the nine available trials, three of the listed trials were wrong, i.e. they were trials for a disease that the patient did not communicate to the matching service provider. Stated differently, three of the nine trials were not for clinical trials associated with breast cancer. The remaining six trials were for clinical trials associated with breast cancer and the closest clinical trial was located in Arkansas.

After receiving the above stated information, the patient used the inventive system and process disclosed herein and provided the exact same information as provided to Service A. The inventive system and process disclosed herein provided the patient with a total of nine clinical trials for triple-negative breast cancer within the state of Michigan and a total of sixty clinical trials for triple-negative breast cancer within the United States. As such, the inventive system and process provided available clinical trial sites at a factor of ten greater than the prior art system.

In an actual matching scenario, once the nine clinical trials within the state of Michigan were identified, the patient would be asked by the matching representative if any of these trials were suitable and would be told which of the trials were located closest to where the patient lived. If the patient stated that they would like to participate in any of the clinical trials, the matching representative would contact a chosen clinical trial site for the patient. After contacting the chosen clinical trials site, the matching representative would determine whether or not the site was accepting patients for that particular clinical trial, and if answered in the affirmative, arrange for contact between the clinical trial site and the patient. In this manner, the patient himself/herself does not have to deal with the potentially burdensome task of contacting one or more clinical trial sites and trying to reach the appropriate individual or individuals to talk to in order to initiate participation within the clinical trial.

It should be appreciated that the process includes searching and/or surveying for available or soon to be available clinical trials within a particular geographic area, e.g. a particular state, a particular group of states, within a particular country, and the like. In some instances, this searching is conducted over the Internet and obtains such information from one or more web pages, websites, etc. In addition, when the search provides or gathers information in the form of medical terms, medical terminology, medical language, and the like, the system and process translates or transforms such medical terms, medical terminology, medical language, etc. into regular language which can be used to produce a survey or questionnaire.

For example, the system and process can search web sites such as www.clinicaltrials.gov and collect data from such a website such as locations of clinical trials, date or dates of starting of clinical trials, inclusion criteria for participating in clinical trials, exclusion criteria for participating in clinical trials, and the like. Upon receiving or gathering such data, the system and process can include communicating with a patient and determining whether or not the patient wishes to participate in one or more clinical trials. In the event that the patient does wish to participate in a clinical trial, a survey or questionnaire can be communicated to the patient and based on feedback from the patient, one or more available or soon to be available appropriate clinical trials for which the patient is qualified to participate in can be selected. As mentioned above, the list of available clinical trials communicated to a patient is independent of any particular organization, company, etc. that is sponsoring and/or funding the clinical trials.

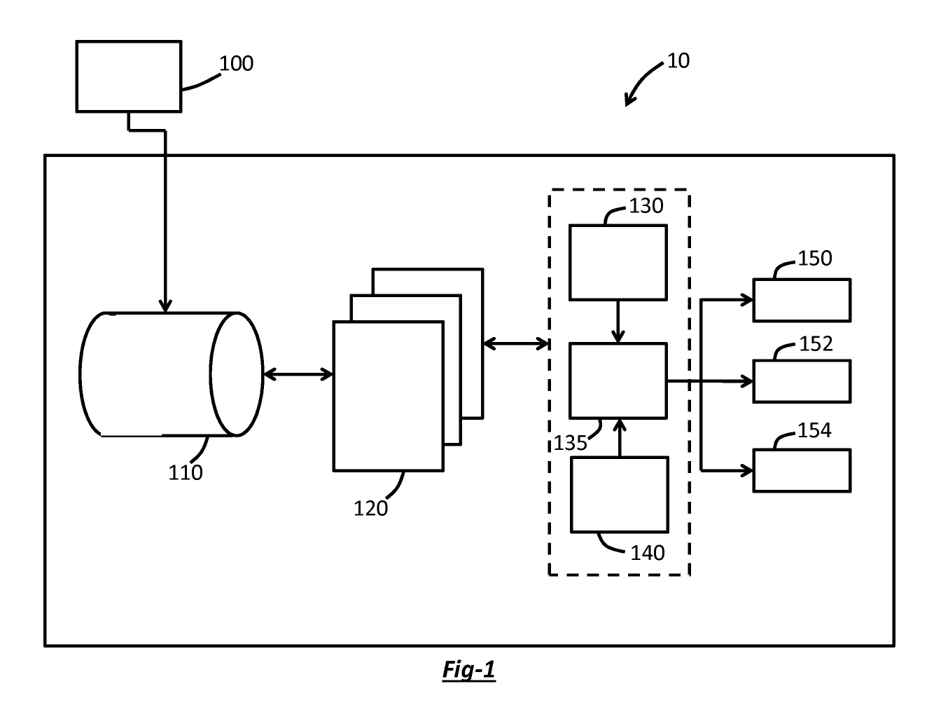

Referring now to FIG. 1, an inventive system is shown in which a website 100 is searched by a translational database 110, which upon finding data on the website 100, translates the data into regular expressions and/or questions to produce a plurality of disease specific health assessments 120. The health assessments 120 can then be used by a relationship manager 130 when communicating with a client/patient 140 using a patient survey module 135 in order to find one or more clinical trial sites 150, 152, 154 that the client/patient 140 is qualified to participate in.

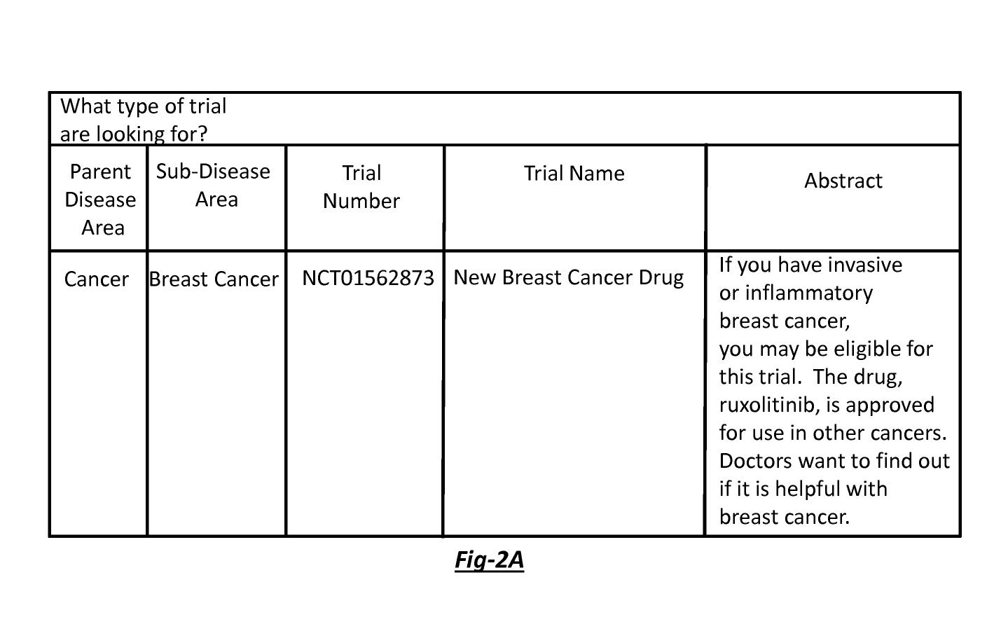

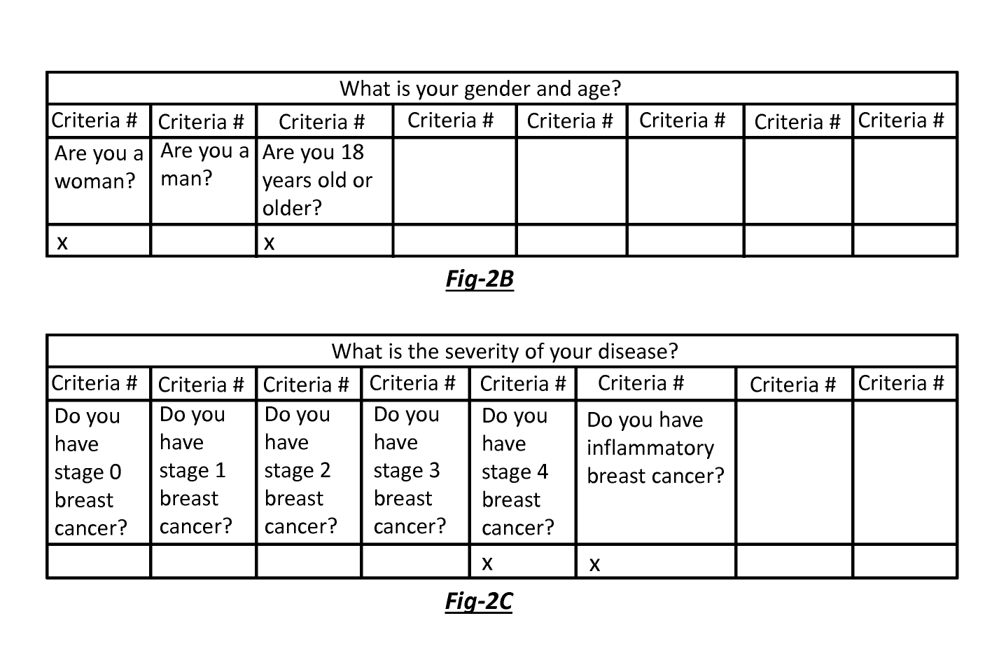

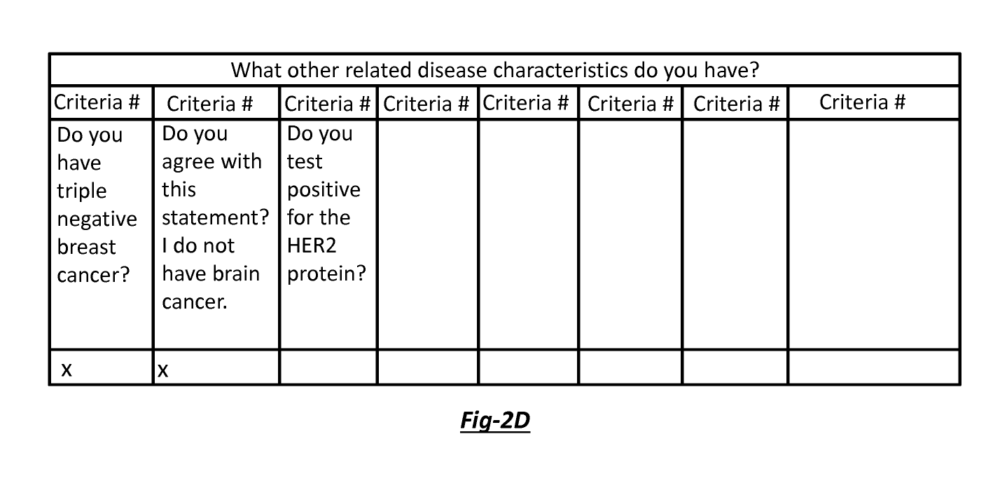

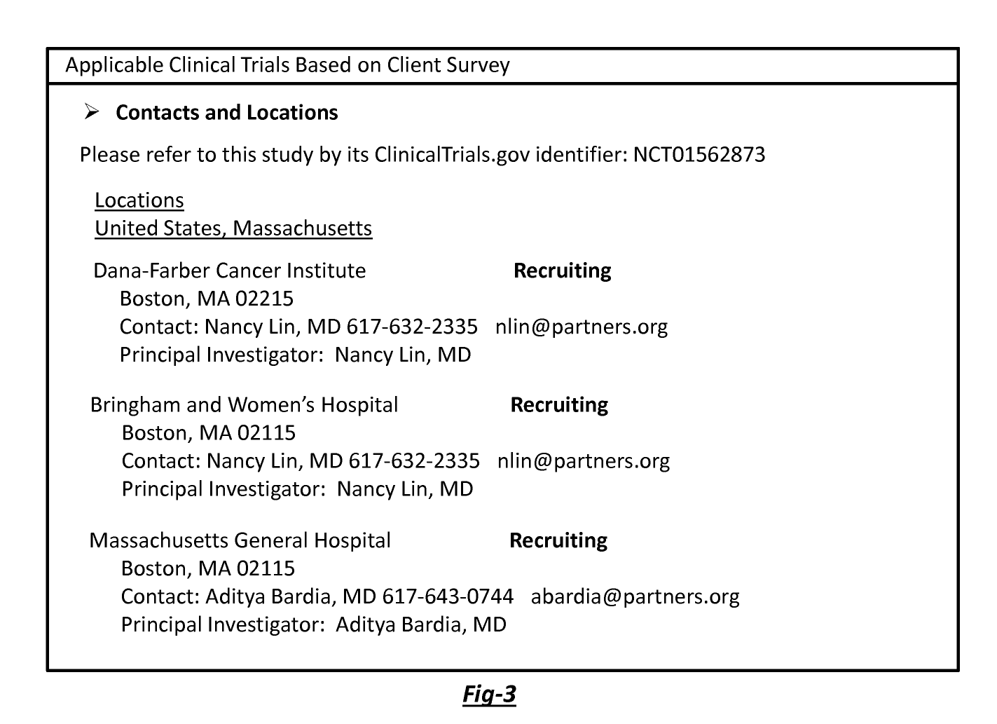

The patient survey module can generate one or more patient surveys. For example, FIG. 2 illustrates an exemplary patient survey with a list or table of questions. For example, FIGS. 2A-2B asks the patient what type of trial they are looking for and what is the patient's age and gender. Next, the questionnaire provides questions regarding what stage the disease has reached and if there are any other disease related characteristics that are present as shown in FIGS. 2C-2D. Naturally, the options or questions shown in FIGS. 2C-2D are a function of the answers provide to the options or questions in FIGS. 2A-2B. Upon asking this series of questions and obtaining answers thereto, the inventive system and process provides any available clinical trials within a given geographical region as shown in FIG. 3.

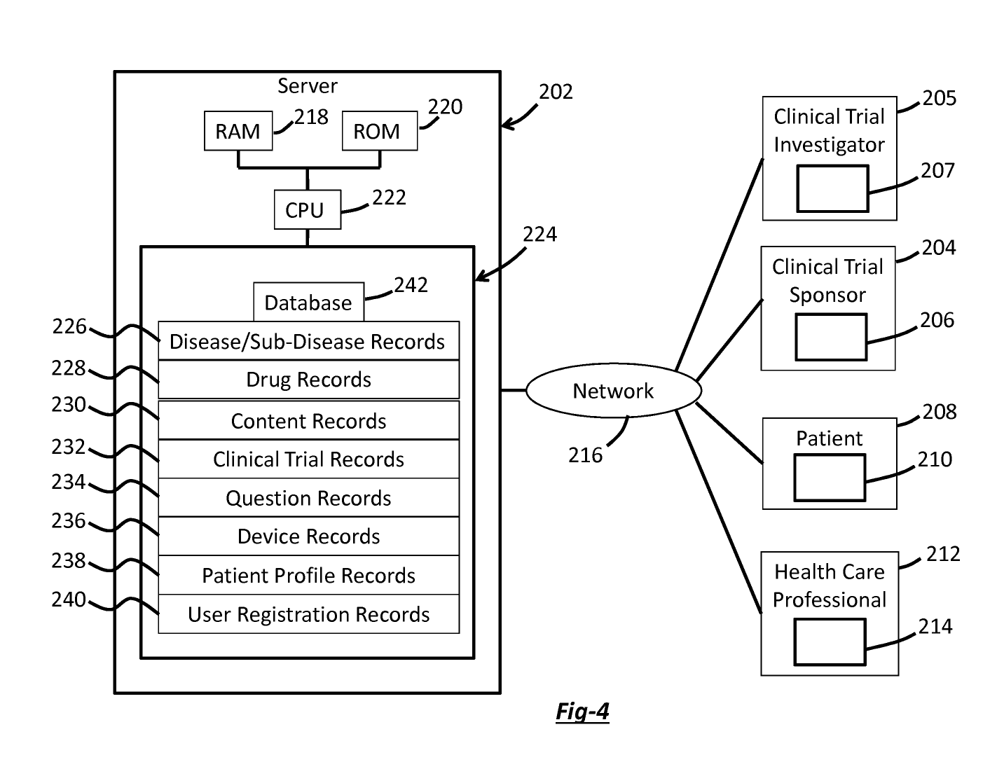

FIG. 4 depicts a block diagram illustrating the system of the present invention. A server 202 is connected to a network 216. Network 216 can be any network connecting computers such as the Internet. Sponsors of clinical trials utilize a clinical trial sponsor terminal 204 to access server 202 and to communicate with other terminals connected to network 216. Clinical trial sponsor terminal 204 is running browser program 206 which allows terminal to access remote servers and communicate with other terminals via network 216.

Patients and other individuals can access server 202 by using patient terminal 208 which is running browser program 210. Healthcare professionals can access server 202 by using health care professional terminal 212 running browser program 214. Clinical trial investigators can access server 202 by using clinical trial investigator terminal 205 running browser program 207. Other individuals can similarly access server 202 by using any terminal connected to network 216.

Server 202 includes a CPU 222 which is running a program which operates the method of the present invention. CPU 222 accesses RAM 218, ROM 220, and data storage device 224. Data storage device 224 can be any magnetic or optical media, or any other medium for storing electronic data. As will be understood by one of skill in the art, server 202 can comprise multiple servers working together, and data storage device 224 can similarly comprise multiple storage devices.

Data storage device 224 contains a database 242. Database 242 contains information organized into records. Some exemplary records are shown in FIG. 4. Disease/sub-disease records 226 contain information related to specific diseases. These records are organized both by disease and sub-disease. An example of a disease is “cancer” and an example of a sub-disease is “skin cancer.” Disease/sub-disease records 226 contain information about the disease such as description of the disease, symptoms, treatment, history, and other pertinent information. Each disease/sub-disease record 226 also includes links to other related records in database 242 such as drug records 228 (e.g. drugs used to treat the disease), content records 230, clinical trial site records 232, question records 234, and device records 236. The links between records are described in more detail with respect to FIG. 4.

Drug records 228 contain information about various drugs. Such information includes the purpose of the drug, compound name, generic name, brand names, instructions for taking the drug, warnings, side effects, and any other pertinent drug information. Each drug record 228 contains links to other records in database 242.

Content records 230 contain various kinds of content such as newspaper and journal articles, research reports, frequently asked questions, standard therapies, alternate medicine, case studies, and various other types of medical information that would be of interest to someone seeking information about diseases and treatments. Content records 230 contain links to other records in database 224.

Clinical trial site records 232 contain information pertaining to various clinical trial sites. Clinical trials are performed for various reasons such as to test the efficacy of a new drug, a new medical device, or a new therapy. Clinical trials are often performed prior to obtaining FDA approval. One clinical trial may take place at multiple clinical trial sites. Each clinical trial site preferably has its own record in clinical trial site records 232. A clinical trial is conducted by an investigator on behalf of a sponsor at a clinical trial site.

Clinical trial site records 232 contain information about the clinical trial site such as the sponsor's name and information, investigator's name and information, location, number of patients admitted, number of patients allowed, open or closed status, drug or device being tested, names of staff, duration of trial, phases of the trial, purpose of the trial, trial methodology, and any other information relevant to the clinical trial being performed. Clinical trial site records 232 contain links to other records in database 242.

Question records 234 contain questions that are asked to users who are seeking to join clinical trials. Patients who are seeking to join clinical trials are asked a series of questions about their disease, their prior treatment, and their medical history. The answers to these questions are used to build a patient profile. If the answers to these question match the acceptance criteria for a specific clinical trial, then the patient becomes eligible to apply for that clinical trial. Question records 234 contain links to other records in database 242.

Device records 236 contain information about various medical devices such as the device manufacturer name, the diseases and conditions treated, instructions for using the device, warnings, and other pertinent device information. Device records 236 contain links to other records in database 242.

User registration records 240 contain user information about the various users authorized to access server 202. User registration records 240 contain information such as user name, user ID number, login name, password, access privileges, customized user preferences, mail accounts, links to patient profiles, and any other similar user information.

Patient profile records 238 contain various types of medical information about patients including their gender, age, medical histories, diseases, symptoms, and any other relevant medical information. Patient profile records are created by asking the patient a series of questions. The responses are used to build the patient's profile. The responses can be entered by a health care professional or by the patients themselves.

In a preferred embodiment of the invention, patient profile records 238 do not contain the user's name, but instead only contain the user's ID number. In other words, the patient's medical information is kept separate from the patient's identifying information. This maintains the user's medical privacy and anonymity. Also, every patient can be assigned a user ID number. The user's name and identifying information is stored in the user's registration record 240 along with the user's ID number. The patient's medical information is stored in a patient profile record 238 along with the patient's user ID number. In this way, the patient's profile record 138 can be sent to a third party without revealing the patient's identity to the third party. In this way, the inventive system and process has access to the patient's identifying information, but third parties do not. Additional records can be added to database 242 for various other purposes. Also, the organization of the records shown in FIG. 4 is by example only, and different organizations and groupings of records is possible.

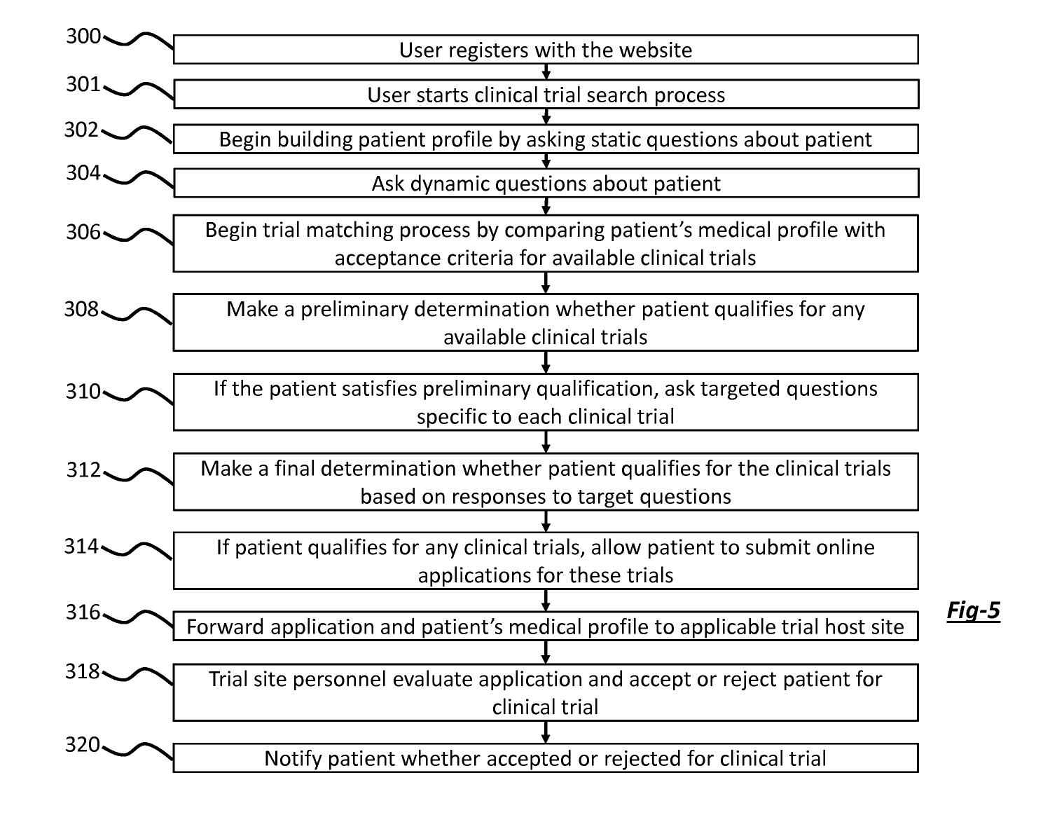

FIG. 5 depicts a flowchart illustrating a method of matching a patient with available clinical trials. In step 300, a user registers with the web site. The user could be a patient, a health care professional such as a doctor, a representative from a clinical trial sponsor, an investigator, a representative from a health care facility or clinical trial site, or any other individual or entity involved in the clinical trial process.

When a user registers, the user selects a user name and a password. The user can also submit an e-mail address. This information can be stored in the user registration record 240. The user is also assigned a user ID number. This user ID number is attached to the user's profile records/medical information in order to keep the user-patient's identity anonymous.

In step 301, a user interested in searching for available clinical trials accesses the web site by entering an appropriate URL. The user then clicks on a link or a series of links that directs the user to the clinical trial search process.

One type of user that might be interested in searching for an available clinical trial is simply a patient or a relative or friend of a patient. The user could also be a health care professional such as the patient's doctor.

The first step in finding appropriate clinical trials is creating a patient profile for the patient. The patient profile will contain the patient's medical information and any of the patient's characteristics that would be useful in determining whether a patient was suitable for a particular clinical trial.

The patient profile is created by asking the user a series of questions. In step 302, the user is asked a series of “static” questions. Static questions are a series of pre-defined questions that are asked about every patient. Examples of static questions include the patient's gender, age, height, weight, name of disease, name of sub-disease, smoker (yes/no), willing to travel (yes/no), and any other pertinent medical or patient information. The user can select a disease and sub-disease from a set of menus. For example, the user could select the disease “cancer” and the sub-disease “skin cancer.” Optionally, the user can select the types of trials for which he or she is interested. For example, the user can select the trial sponsor type, trial modality, trial type of study, and drug or compound name.

Note that the “user” is not necessarily the “patient.” As an example, a patient's doctor could be the “user” who accesses the web site. The patient's doctor then enters information about the patient to build the patient profile. Using this example, the patient's doctor is doing the searching for clinical trials on behalf of the patient. In step 304, the user is asked a series of “dynamic” questions about the patient. The dynamic questions are questions which are selected based on the user's previous answers to other questions. Many of the dynamic questions will be questions which are unique to the specific selected disease and sub-disease.

When the user is presented with questions, the user is also presented with a group of answer options. The user can click on one or more of the answer options to respond to the question (some questions only allow one answer option to be selected, whereas other questions allow multiple answer options to be selected).

Preferably the questions asked to the patient, and the answer options provided to the patient, are such that a computer software program can evaluate and score the answers to the questions, rather than having a human being evaluate the answers. For example, one type of question that is easy to evaluate and/or score by a computer program is a question that allows the patient to choose one or more answers from a set of discrete multiple-choice answers. This type of question is very easy for a computer to evaluate and/or assign a score. As another example, if the patient is required to enter a numerical number, such as enter the patient's blood pressure, height or weight, this is also very easy for a computer to evaluate and/or assign a score. However, if the patient were asked “Please describe your pain” and then the patient were allowed to enter a text message, then a computer would have a difficult time evaluating this answer. A human would have to read the answer and evaluate the answer.

Some example questions are presented as follows: Please select any or all prior cancer treatments (followed by a list of treatments, patients can click on any treatments they have had). How many times did you have surgery? Please select all dates that correspond to your surgeries (followed by a list of dates that the patient can click on). Select all surgical procedures performed to date. Was your surgery followed by (followed by a list of choices)? Was your surgery proceeded by (followed by a list of choices)? How many chemotherapy regimes have you received? Please select all dates that correspond to your chemo treatment. Which organs are affected by malignancies at this time? What is the stage of cancer at the time of diagnosis?

The user can be asked different levels of dynamic questions. For example, depending on the user's answer to a particular question, the user can be asked a follow-up dynamic question. If the user answers this question in a certain way, the user can be asked another follow-up question to the follow-up question. In this way the user is automatically steered through the process of building a patient profile. As an example, if the user selects “Lung Cancer” as a disease, the user could be asked “Are you a smoker?” If the user selects “YES”, then the user could be asked: “How many cigarettes a day do you smoke?.” If the user selects “More than five”, then the user could be asked “How many years have you smoked?” In this way the user is steered through the process of building a patient profile.

Once all the questions have been answered, static and dynamic, a patient profile is created. The patient may save the profile for later use. The patient profiles are stored in patient profile records 238 in database 242. In step 306, server 202 begins a process of determining whether the patient's profile matches any available ongoing clinical trials by comparing the patient's profile with acceptance criteria for available on-going clinical trials.

As explained previously, the answers requested from the users are suitable for a computer software program to score and evaluate. Thus, a computer program process can automatically determine whether the patient prequalifies. This eliminates the need to have people review the patient's profile to determine prequalification.

In step 308, the system makes a preliminary determination of whether the patient qualifies for any available on-going clinical trials. The trial matching is preferably done at the trial site level, not the trial level. For example, a drug manufacturer may be sponsoring a clinical trial for a new drug at many trial sites around the country. The patient's profile is compared to each individual trial site to determine whether the patient prequalifies for that individual trial site. Different trial sites for the same trial could have different acceptance criteria. For example, a particular trial site may be limited to patients living within twenty miles of the trial site.

One method that can be used to determine whether a patient prequalifies for a particular trial site, is that the patient prequalifies for a trial site only if the patient meets all of the acceptance criteria for that specific trial. For example, a trial site could require that a patient must be female between the ages of 30-40 who has breast cancer, does not drink alcohol, and lives within twenty five miles of New York City. If the patient meets all of these criteria, then the patient will be prequalified for that trial site.

An alternative method of prequalifying patients is to calculate a score based on the answers given by the patient. For example, the score could simply be the number of criteria met by the patient. More complicated algorithms could also be used to generate a score. For example, the score could include the patient's blood pressure divided by two, plus three times the patient's age, and so on. The patient would then qualify only if the score exceeded or was less than a predetermined threshold or within certain predetermined threshold limits. There can also exist a combination of a score threshold, and criteria which must be satisfied in order to qualify. For example, in order to qualify for a particular trial site, patients could be required to be female, over 35, and have a score over 253 where the score is based on a number of other factors.

Some examples of acceptance criteria that can be used include: the patient must be within a certain age range, must be female, must live within a certain geographic region, must have skin cancer, must have not had previous surgery, must have been diagnosed with cancer within the last six months, cancer must not have spread to other body organs, etc.

As mentioned previously, the users are required to enter answers to patient profile questions in a format that is suitable for evaluation by a computer program process. Optionally, the user could be provided with a combination of questions: some questions requiring answers in numerical or multiple choice format, and some questions requiring a text description to be entered by the user. The former type of questions are used to perform the automatic prequalification of the patient. The descriptive answers entered by the patient could later be sent to the clinical trial site for evaluation by clinical trial site personnel.

Acceptance criteria for clinical trial sites are typically provided by the clinical trial sponsors. Alternatively, the acceptance criteria could also be provided by clinical trial site investigators. One method of providing acceptance criteria to the inventive system and process is to have the clinical trial sponsor or clinical trial investigator provide acceptance criteria to server administration personnel. The acceptance criteria could be sent by regular mail, by fax, by e-mail, over the telephone or any other communication method. The server administration personnel then program server 202 to use the acceptance criteria to qualify patients for that particular clinical trial.

An alternative method is to allow clinical trial sponsors and/or clinical trial investigators to be provided with access privileges to the server 202. The sponsors or investigators could then access the web site via network 216. A link or group of links would direct the sponsors or investigators to a web page that allows the sponsors/investigators to automatically enter acceptance criteria. Database 242 is scaleable and updateable by personnel. In some instances, other parties such as clinical trial sponsors and investigators can be given access privileges (as described above) to enter data such as acceptance criteria, questions, answers, etc. The static and dynamic questions asked to patients to build their patient profile can be updated and/or supplemented frequently to reflect new medical developments, trial site selection criteria, new clinical trials, amendments to clinical trial protocols, and other developments.

Users can also be informed of the number of trials for their disease for which the patient does do not qualify, or how many trials are currently closed, or potentially if there is a waiting list available for which the patients can sign up. For example, the user could be informed that for skin cancer there are currently ten trials available and the patient qualifies for three of those ten.

After the system has made a preliminary determination of whether the patient prequalifies for any clinical trials, in step 310 the system can provide targeted questions specific to each clinical trial for which the patient has preliminarily qualified. Once the system has received responses to these targeted questions, then in step 312 the system makes a final determination as to whether the patient prequalifies for any of the clinical trials based on the user's responses to the targeted questions.

In step 314, if the patient prequalifies for any clinical trials, the patient is then provided with an application to fill out. The patient is allowed to submit an-line application for each trial site for which he or she qualifies. The patient's applications and medical profile are submitted online to server 202. Alternatively, the patients could submit their applications and profiles by other methods such as by mail or by facsimile.

In step 316, the patient's applications are forwarded along with the patient's medical profile to the appropriate trial site investigators or designated staff. The applications can be submitted to the trial site online, or alternatively, by other methods such as mail or facsimile. As described previously, the patient's medical profile and application preferably does not contain the patient's name, social security, and other identifying information. The patient's medical profile and application only include a patient ID number. In this way, the patient's privacy is protected in accordance with government regulated confidentiality standards. A copy of the patient's application/profile, a summary of the patient's application/profile, or a notification could optionally be sent to the trial sponsor in addition to the trial site.

As an alternative to submitting applications to the trial sites via web server 202, the applications could alternatively be submitted directly by the patient to the trial site investigators or staff. However, it may be preferable to send all information to the trial site via server 202 in order to maintain the privacy of patients' identity.

Another method of sending the patient's application and profile to the trial site investigator is as follows. The trial site investigator or contact person has a designated “mailbox” in a message center on server 202. The patient therefore sends a message to the investigator/contact person containing the application and profile. This message is then stored on the server 102 and can be retrieved by the investigator/contact person.

In step 320, the patient is notified whether he or she has been successfully prescreened or rejected for the clinical trial site which the patient has applied. The patient can be telephoned or e-mailed or contacted by other means. Alternatively, the patient can access the web site and check his or her status. If the patient has successfully prequalified for a clinical trial site, the patient can be provided with contact information at the trial site. The patient can then contact the appropriate person at the trial site (either through a message left in the server 202 message center or through other contact means) to inquire about enrolling in the clinical trial site or to seek further information. The clinical trial site may then require that the patient undergo further medical testing or answer further questions before the patient is enrolled in a clinical trial.

Another feature provided by server 202 is to allow users to search and obtain medical information about diseases, drugs, medical devices, treatments, clinical trials, and any other pertinent information. In this way, patients and health care professionals can educate themselves about a disease, standard or experimental treatments, and ongoing clinical trials before deciding whether to participate in any clinical trials. This process is enhanced by providing many links between the various records shown in database 242 in FIG. 4.

The method just described and shown in FIG. 5 is a method of matching patients with clinical trial sites. The system of the present invention can also perform other types of matching such as: patient to patient matching trial sponsor to investigator matching investigator to trial site matching and the like.

Patient to patient matching involves matching one patient with another patient based on their patient profiles. For example, a patient with a particular disease could be matched with other patients with a similar disease. This allows the patients to automatically form a support group. A patient could be provided e-mail addresses of other matching patients so that they can be contacted. Each patient could be provided with an anonymous e-mail name so that the patient privacy can be protected. Alternatively, messages could be addressed to a user ID number.

Trial sponsor to investigator matching involves matching a clinical trial sponsor with an investigator suitable for conducting the trial. For example, a drug company might be interested in finding a researcher with 20 years of experience researching breast cancer treatment in the Milwaukee area. Investigator to trial site matching involves matching investigators with trial sites that are looking for investigators with particular qualifications. What all of these methods share in common is that the server 202 finds matches between matching parties and performs an initial layer of prequalification or prescreening before bringing the parties together.

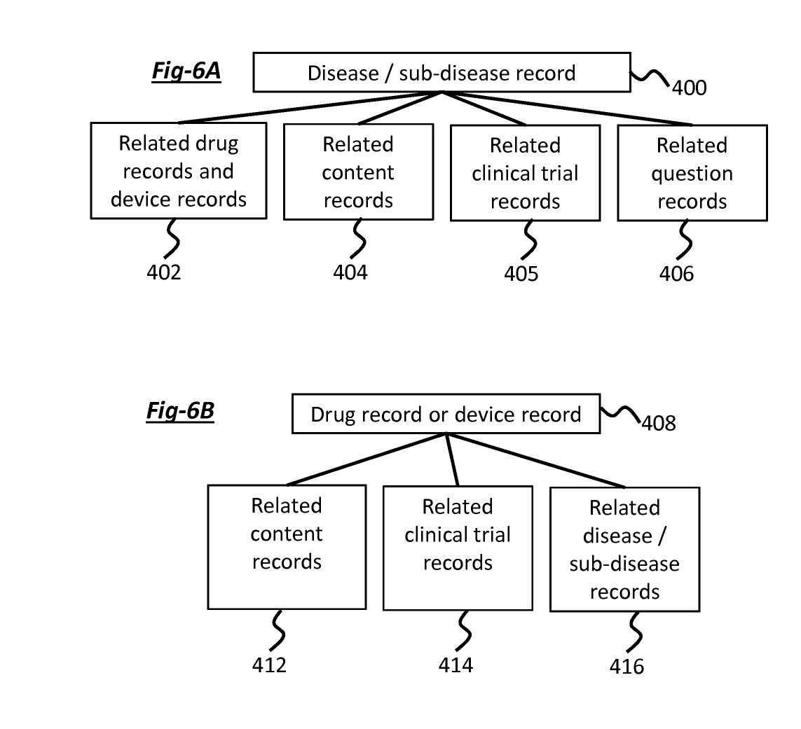

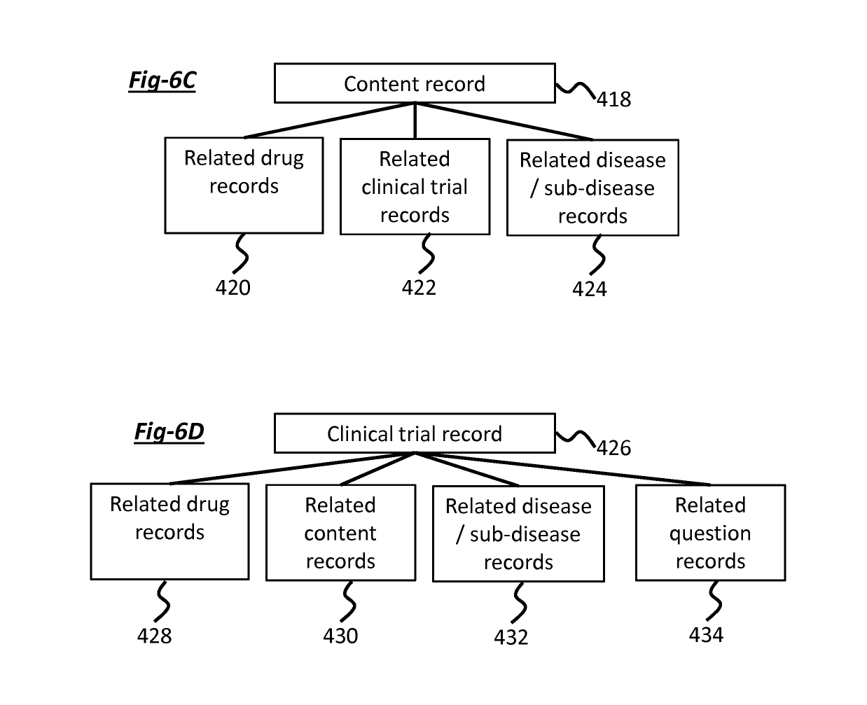

FIG. 6A depicts a block diagram illustrating some exemplary links between various records in data storage device 220. These links allow a user to navigate the web site and efficiently find medical information relevant to their particular medical condition. The user can also search for relevant information by entering keyword queries. For example, a user searching for particular information about a particular disease would enter the name of a disease and sub-disease such as “cancer/skin cancer.” This would retrieve disease/sub-disease record 300 for skin cancer. Disease/sub-disease record 400 would contain information about skin cancer which would be provided to the user. When the user accesses disease/sub-disease record 300, the user is provided with all of the information contained in record 400 as well as links to records 402, 404, 405, and 406. The user can then click on one of these links to access the linked record.

Disease/sub-disease record 400 contains links to related drug/device records 402. These drug/device records are associated with drugs and medical devices used to treat the disease/sub-disease associated with disease/sub-disease record 400. The drug/device records 402 contain information about their associated drug or device such as instructions for taking a drug or using a medical device, warnings, side effects, and similar information.

Disease/sub-disease record 400 also contains links to content records 304. Content records 404 contain additional information about the disease/sub-disease such as related news and journal articles, standard therapies, therapies in development, case studies, alternative treatments, and frequently asked questions.

Disease/sub-disease records 400 also contain links to clinical trial records 404. Clinical trial records 404 contain information about various clinical trials which address the specific disease/sub-disease such as the clinical trial sponsor type, trial site locations, acceptance criteria, number of people admitted, and so on. Disease/sub-disease records 400 also contain links to related question records 406. These are questions that are asked to users who are seeking to qualify for clinical trials. These questions are asked in step 304 in FIG. 5.

FIG. 6B shows another set of links emanating from drug or device record 408. A user can access a drug or device record 408 to find out information about that drug or device. The user will be presented with links to related content records 412 which provide content related to that drug or device. The user will also be presented with links to related clinical trial records 414. The user will also be presented with links to related disease/sub-diseases records 416.

FIG. 6C shows another set of links emanating from content record 418. Content record 418 could be a news or journal article, or some other piece of information. Content record 418 contains links to related drug records 420, related clinical trial records 422, and related disease/sub-disease records 424.

FIG. 6D depicts another set of links emanating from clinical trial record 426. Clinical trial record 426 contains links to related drug records 428, related content records 430, and related disease/subdisease records 432. Clinical trial record 426 also contains links to related question records 434. These questions are asked to users in step 310 of FIG. 5 to determine if they qualify for the specific clinical trial.

Another embodiment of the invention provides a clinical trial match underwriting system that takes patients' medical record from hospitals or insurance companies and processes such records through a proprietary underwriting algorithm and finds potential clinical trial matches for patients. The clinical match underwriting system can have at least three components: (1) a patient data retrieval and management system (PDRMS); (2) a clinical trial management system (CTMS); and (3) an underwriting system.

Regarding the PDRMS, this component affords for the retrieval and/or reading of patient electronic medical records from various electronic medical records systems/databases that hospitals or insurance companies have or use. The PDRMS retrieves data from the various systems in its native format and normalizes the data such that the patient medical data is standardized and can be utilized by the underwriting system. The PDRMS categorizes patients by medical conditions into predefined categories, for example, categorizing patients into different disease types illustratively including diabetes, lung cancer, leukemia, etc.

The PDRMS also creates decision variables based on patient information and medical data. For example and for illustrative purposes only, decision variables derived from patient data by the PDRMS can include:
Age—calculated from patient's date of birth and can be put into an integer variable called “age”.
Surgery during past 12 months—derived from patient's surgery history and put into a Boolean variable called “surgery during past 12 month”.
Chest x-ray in the past 12 month—derived from patient's medical history and put into a Boolean variable called “chest x-ray in the past 12 month”
Smoker—derived from patient's information and put into a Boolean variable called ‘smoker”.
Currently on antidepressant—derived from patient's medication records and put into a Boolean variable called “currently on antidepressant”.

It is appreciated that deriving the age variable can be relatively simple since such information is directly available from a patient's electronic medical record. It is also appreciated that deriving variables such as “chest x-ray in the past 12 months” can be more complicated. As such, the PDRMS affords for customized mapping of patient electronic medical records to a standardized patient data format. The PDRMS also has advanced querying methods, keyword searching and text analytics to interrogate a patient's original electronic medical record data in order to populate the patients' decision variables that will be used by the underwriting algorithm to find potential clinical trial matches.

Regarding the CTMS, this component can be a database that contains the latest clinical trials obtained from government compiled data and/or independent research data. The CTMS also allows medical researchers to update and maintain up-to-date clinical trial data, as well as create clinical trial enrollment criteria that can be utilized by the underwriting algorithm to interrogate patient's medical records to find potential matches.

The CTMS also provides medical researchers with functionalities to create, update and maintain clinical trials and trial sites information and/or create enrollment criteria and assign such criteria to specific clinical trials. It is appreciated that each enrollment criteria is essentially the value or range of values of each patient decision variable created in the PDRMS. For example and for illustrative purposes only, enrollment criteria can include:
Patient's sex=Female
Patient's age ≧40
Smoker=False
major surgery in the past 12 month=False
currently on antidepressant medication=False

It is known that clinical trials can be categorized by medical conditions, for example, diabetes Type II, COPD, skin cancer, etc. As such, certain enrollment criteria are generic and can be assigned to a group of medical conditions and referred to as generic enrollment criteria. In contrast, some of the enrollment criteria can be unique to a particular clinical trial. For example, one trial might only enroll a patient from a particular hospital or another trial might only enroll a patient from intensive care unit. Such enrollment criteria can be referred to as trial-specific enrollment criteria.

Regarding the underwriting system, this component users of the invention to create customized underwriting decision models for various disease types and medical conditions. The underwriting system also affords for processing of a patient's medical data through a decision model and return of one or more potential clinical trial matches.

Since the CTMS allows a user to create unique enrollment criteria for each clinical trials, the underwriting system can treat a combination of both generic enrollment criteria and trial-specific enrollment criteria that are related to a particular clinical trial as one decision model. For example and for illustrative purposes only, a trial-specific decision model of one particular Type 2 diabetes clinical trial can be:
Age >18 and Age <100
Medical condition=Type 2 Diabetes
Pregnant=False
Organ transplant within the past year=False
Medical condition < > onset hyperglycemia
Medical condition < > liver disease
Insulin dosage ≦0.6 units/kg

The underwriting system also allows a user to create a customized generic decision model that covers a group of clinical trials, for example all COPD clinical trials or a particular group of COPD clinical trials. Similar to the above trial specific decision model, generic decision models include only generic enrollment criteria. An example of a generic decision model for all Type 2 diabetes clinical trials can be:
Age >18 and Age <100
Medical condition=Type 2 Diabetes
Pregnant=False
Medical condition < > onset hyperglycemia
Medical condition < > liver disease

The underwriting system may or may contain a proprietary decision engine that can accept a patient record, read the patient's decision variables, run or process the variables against enrollment criteria in a decision model and produce a list of clinical trials that match all or partial criteria in the decision model.

It is appreciated that typical clinical trials are conducted at multiple sites, i.e. different physical locations. Geographical information such as a zip code, a distance from a particular trial site, etc., can be created as patient decision variable as well as enrollment criteria. For example, a generic enrollment criterion can be created as below:
Distance to clinical trial sites ≦50 miles
   In addition, the decision engine would compare the distance between the zip code where patient lives and the zip code of clinical trial sites and use the above enrollment criterion to further narrow down the clinical trial results to find the right sites that match the criteria.

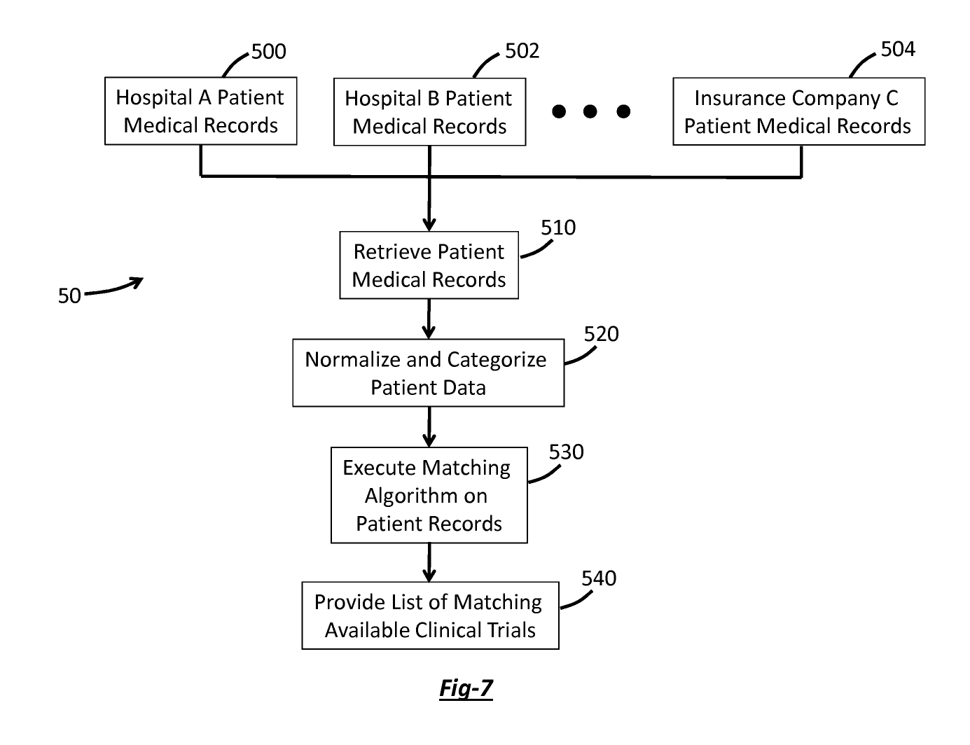

Turning now to FIG. 7, a schematic illustration of such as system is shown generally at reference numeral 50. The system or process 50 includes one or more patient medical records databases, e.g. a Hospital A patient medical records database 500, a Hospital B patient medical records database 502, an Insurance Company C patient medical records database 504 and the like. It is appreciated that patient medical records can also be contained in, and obtained from, an online health community, a social media network, a patient advocacy organization, and the like. Stated differently, a computer using a system and/or process according to an embodiment of the present invention has a direct link or direct access to, i.e. can read data from a hospital database, an insurance company database, an online health community, a social media network, a patient advocacy organization, and the like.

The system 50 retrieves patient medical records from the one or more patient medical records databases at 510. Thereafter, the retrieved patient medical records are normalized and/or categorized at 520. Then, the normalized and/or categorized patient medical records are subjected to or processed with a customizable clinical trial matching algorithm at 530. The result of the execution of the customizable clinical trial matching algorithm on the normalized and/or categorized patient medical records affords for a list of available clinical trials that match a particular patient's profile at 540. In the alternative, result of the execution of the customizable clinical trial matching algorithm on the normalized and/or categorized patient medical records affords for a list of patients that fit a particular clinical trial and/or a particular clinical trial at a particular geographic location.

In addition to FIG. 7, an illustrative example how the inventive system can load an insurance company's patient database and use a decision model to find potential matches for a COPD clinical trial is described below.

ABC insurance company has a database of patient records. After gaining access to the patient records database, the PDRMS retrieves patient records, e.g. one at a time, and categorizes and compiles patient medical information. For example, and assuming the database has three patient records: Tom Smith, John Doe, and Susan Bush, a a list of patient decision variables predefined in the system can be:
Age
Smoker?
Diagnosed with COPD
X-Ray within the past 12 month?
Lung biopsy in the past 12 month?
Been prescribed with Perforomist® Inhalation Solution in the past?
Heart attack in the past 6 months
Allergic to albuterol?

As such, the PDRMS reads Tom Smith's record from the ABC Insurance Company's database and retrieve Tom Smith's basic information like name, address, zip code, date of birth, etc. The PDRMS also save Tom Smith's basic information. The system also interrogates Tom Smith's electronic medical records to populate the aforementioned decision variables for Tom. For example, Tom Smith's records provide:
Age=45
Smoker?=True
Diagnosed with COPD=True
Radiation or chemotherapy within the past 12 month?=No
Lung biopsy in the past 12 month?=No
Been prescribed with Perforomist® Inhalation Solution in the past?=No
Heart attack in the past 6 months=No
Allergic to albuterol?=No

The PDRMS also reads the next patient's data, John Doe, from the ABC Insurance Company database. For example, John Smith's decision variables are populated with the data:
Age=24
Smoker?=True
Diagnosed with COPD=No
Radiation or chemotherapy within the past 12 month?=No
Lung biopsy in the past 12 month?=No
Been prescribed with Perforomist® Inhalation Solution in the past?=No
Heart attack in the past 6 months=No
Allergic to albuterol?=No

The PDRMS then reads the next patient's data, Susan Bush, from ABC Insurance Company database with Susan Bush's decision variables populated with the data:
Age=55
Smoker?=True
Diagnosed with COPD=Yes
Radiation or chemotherapy within the past 12 month?=No
Lung biopsy in the past 12 month?=No
Been prescribed with Perforomist® Inhalation Solution in the past?=No
Heart attack in the past 6 months=Yes
Allergic to albuterol?=No

As stated above, the CTMS System can have a list of COPD clinical trials and enrollment criteria for these trials. Also, the underwriting system has a generic decision model called COPD-12 created for a group of ten COPD clinical trials. For example, the generic decision model can be:
Age >=40
Smoker?=True
Diagnosed with COPD=True
Radiation or chemotherapy within the past 12 month?=No
Lung biopsy in the past 12 month?=No
Been prescribed with Perforomist® Inhalation Solution in the past?=No
Heart attack in the past 6 months=No
Allergic to albuterol?=No

The underwriting system processes each patient, i.e. the data for each patient, through the decision model. As such, patient Tom Smith's profile passes the decision model, however, John Doe and Susan Bush's profile did not pass the decision model. The underwriting system then produces a list of matched clinical trials for Tom Smith.

The system can further find clinical trial sites that are within a specified distance to a patient. For example, and assuming from the previous example that the ten matched clinical trials have 25 sites across the country. The system affords for a comparison or analysis of Tom Smith's zip code and provide a list of clinical trial sites within a specific distance to Tom Smith, e.g. less than 50 miles.

Although the present invention has been described in terms of various embodiments, it is not intended that the invention be limited to these embodiments. Modification within the spirit of the invention will be apparent to those skilled in the art. As such, the scope of the invention is defined by the claims and all equivalence thereof.

I claim:

1. A system for matching patients to available clinical trials, said system comprising:
a computer with a CPU having a processor, memory and an electronic database, said electronic database having a language equivalency database, said language equivalency database having a thesaurus of medical terminology and a regular language translator, said regular language translator operable to translate medical terms in said thesaurus of medical terminology into regular language terms;
said electronic database also having a clinical trials database, said clinical trials database having available clinical trials data for available clinical trials within a given geographic area;
said computer having a patient survey module with a plurality of questions generated from said regular language translator by said computer, said patient survey module operable to accept answers to said plurality of questions as patient data; and
a clinical trial matching module operable to select an available clinical trial for a patient as a function of said patient data.

2. The system of claim 1, wherein said plurality of questions are a series of sequential questions having previous questions and subsequent questions, said patient survey module operable to alter at least one subsequent question as a function of patient data accepted for at least one previous question.

3. The system of claim 2, wherein said plurality of questions are in the form of a logic tree.

4. The system of claim 3, further including a message module, said message module operable to send said selected available clinical trial to at least one of said patient, a caregiver, a specific clinical trial location and a clinical trial sponsor.

5. The system of claim 1, wherein said patient data is obtained directly from said patient during a conversation with said patient.

6. The system of claim 5, wherein said conversation is a phone conversation.

7. The system of claim 1, wherein said patient data is obtained from a database selected from the group consisting of a hospital database, an insurance company database, an online health community database, a social media network database and a patient advocacy organization database.

8. The system of claim 7, wherein said patient data is translated into answers for said plurality of questions by said regular language translator.

9. A process for matching a patient to an available clinical trial, the process comprising:
providing a computer with:
a CPU having a processor, memory and an electronic database, the electronic database having a language equivalency database, the language equivalency database having a thesaurus of medical terminology and a regular language translator, the regular language translator operable to translate medical terms in the thesaurus of medical terminology into regular language terms;
the electronic database also having a clinical trials database, the clinical trials database having available clinical trials data for available clinical trials within a given geographic area;
the computer having a patient survey module with a plurality of questions generated from the regular language translator by the computer, the patient survey module operable to accept answers to the plurality of questions as patient data; and
a clinical trial matching module operable to select an available clinical trial for a patient as a function of the patient data;
generating a patient survey with the plurality of questions;
obtaining answers to the plurality of questions from a patient and entering the answers into the patient survey; and
selecting an available trial for the patient as a function of the answers.

10. The process of claim 9, wherein the plurality of questions are in the form of a logic tree.

11. The process of claim 9, further including the computer having a message module, the message module sending the selected available clinical trial to at least one of the patient, a caregiver, a specific clinical trial location and a clinical trial sponsor.

12. The process of claim 9, wherein the patient data is obtained directly from the patient during a conversation with the patient.

13. The process of claim 12, wherein the conversation is a phone conversation.

14. The process of claim 9, wherein the patient data is obtained from a database selected from the group consisting of a hospital database, an insurance company database, an online health community database, a social media network database and a patient advocacy organization database.

15. The process of claim 14, wherein the patient data is translated into answers for the plurality of questions by the regular language translator.
